(19) United States
(12) Patent Application Publication
(10) Pub. No.: US 2009/0202822 A1
(43) Pub. Date: Aug. 13, 2009

(54) POLARIZER PROTECTIVE FILM, POLARIZING PLATE, AND IMAGE DISPLAY APPARATUS

(75) Inventors: Hiroaki Hasegawa, Osaka (JP); Naofumi Tsujino, Osaka (JP); Hideo Asano, Osaka (JP); Tsuyoshi Chiba, Osaka (JP); Naoki Tomoguchi, Osaka (JP); Youichirou Sugino, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/301,664

(22) PCT Filed: May 14, 2007
(86) PCT No.: PCT/JP2007/059895

§ 371 Date: Nov. 20, 2008

(30) Foreign Application Priority Data
May 26, 2006 (JP) 2006-146273

(51) Int. Cl. B32B 27/08

(52) U.S. Cl. 428/339

(57) ABSTRACT

Provided is a polarizer protective film, which has high heat resistance, high transparency, high optical characteristics, and high mechanical strength, and is excellent in adhesion with respect to a polarizer. Further, provided are a polarizing plate using the polarizer protective film and a polarizer, which has high adhesion with respect to the polarizer protective film and the polarizer and is excellent in optical characteristics, and in particular, excellent in transmittance as viewing angle characteristics, and an image display apparatus of high quality using the polarizing plate. The polarizer protective film of the present invention includes a cellulose-based resin layer having a thickness of 0.3 to 3 μm on at least one surface of a transparent resin layer containing a (meth)acrylic resin having a lactone ring structure.

### TECHNICAL FIELD

The present invention relates to a polarizer protective film, a polarizing plate using the same, and an image display apparatus such as a liquid crystal display device, an organic EL display device, or a PDP including at least the one polarizing plate.

### BACKGROUND ART

A liquid crystal display device must have polarizing plates arranged on both sides of a glass substrate forming the surface of a liquid crystal panel due to its image forming system. An example of such a polarizing plate to be used is generally manufactured by attaching a polarizer protective film formed of a cellulose-based resin film such as triacetyl cellulose or the like on each side of a polarizer made of a polyvinyl alcohol-based film and a dichromatic material such as iodine by using a polyvinyl alcohol-based adhesive.

However, a cellulose-based resin film has insufficient heat and humidity resistance and thus has a problem in that properties such as a degree of polarization and a hue of a polarizing plate degrade when a polarizing plate using a cellulose-based resin film as a polarizer protective film is used under high temperature or high humidity conditions. Further, a triacetyl cellulose film causes retardation with respect to incident light in an oblique direction. With recent increase in size of a liquid crystal display, increasingly, the retardation has significant effects on viewing angle characteristics. There is a particular problem of insufficient transmittance as viewing angle characteristics.

As a resin material excellent in heat resistance and optical transparency, a (meth)acrylic resin such as polymethylmethacrylate is well known. However, the (meth)acrylic resin is brittle and is easily cracked, which causes a problem in transportation such as breakage during film transportation, resulting in poor productivity and the like. Therefore, it is difficult to use the (meth)acrylic resin as it is for a polarizer protective film.

In order to solve the above-mentioned problems, a polarizer protective film is proposed, which is formed of a composition composed of an acrylic resin (A) containing methyl methacrylate as a main component and a toughness modifier (B) (preferably, shock resistant acrylic rubber-methyl methacrylate graft copolymer and a butyl-modified acetyl cellulose) (see Patent Document 1). However, the polarizer protective film has a problem in that a relatively great amount of the toughness modifier (B) is used so as to enhance the mechanical strength (acrylic resin (A)/toughness modifier (B)=60/40 to 90/10 in a weight ratio), and consequently, the high heat resistance, high transparency, and high optical characteristics originally owned by the acrylic resin (A) may be impaired.

On the other hand, as a resin having higher heat resistance, higher transparency, and higher mechanical strength compared with a conventional (meth)acrylic resin such as methyl methacrylate, a (meth)acrylic resin having a lactone ring structure is known (see Patent Documents 2 to 5). However, in the case of using the (meth)acrylic resin having a lactone ring structure as a polarizer protective film as it is, there is a problem in that the adhesiveness with the polarizer is not good. Further, in the case of using the (meth)acrylic resin having a lactone ring structure as a polarizer protective film as it is, when an easy adhesion treatment (for example, a corona treatment) is conducted with respect to a film surface so as to enhance the adhesion with respect to the polarizer, a cohesive failure may occur in the vicinity of the surface of the film, and the adhesion with respect to the polarizer may not be exhibited sufficiently.

### Patent Document 1: JP 05-119217 A

### Patent Document 2: JP 2000-230016 A

### Patent Document 3: JP 2001-151814 A

### Patent Document 4: JP 2002-120326 A

### Patent Document 5: JP 2002-254544 A

### DISCLOSURE OF THE INVENTION

### Problems to be Solved by the Invention

The present invention has been made in view of solving the above-mentioned conventional problems, and an object of the present invention is to provide (1) a polarizer protective film having high heat resistance, high transparency, high optical characteristics, and high mechanical strength, and being excellent in adhesion with respect to a polarizer, (2) a polarizing plate using the optical protective film and a polarizer, which has high adhesion with respect to the polarizer protective film and the polarizer and is excellent in optical characteristics, excellent in transmittance as viewing angle characteristics, and (3) an image display apparatus of high quality using the polarizing plate.

### Means for Solving the Problems

A polarizer protective film of the present invention includes a cellulose-based resin layer having a thickness of 0.3 to 3 μm on at least one surface of a transparent resin layer containing a (meth)acrylic resin having a lactone ring structure.

In a preferred embodiment, the cellulose-based resin layer is formed by applying a cellulose-based resin solution obtained by dissolving a cellulose-based resin in a solvent to at least one surface of the transparent resin layer, followed by drying.

According to another aspect of the present invention, a polarizing plate is provided. The polarizing plate of the present invention is obtained by laminating a cellulose-based resin layer side of the polarizer protective film of the present invention on at least one surface of a polarizer formed of a polyvinyl alcohol-based resin.

In a preferred embodiment, the polarizing plate includes an adhesive layer between the cellulose-based resin layer of the polarizer protective film and the polarizer.

In a preferred embodiment, the adhesive layer is formed of a polyvinyl alcohol-based adhesive.

In a preferred embodiment, the polarizing plate further includes a pressure-sensitive adhesive layer as at least one of an outermost layer.

According to another aspect of the present invention, an image display apparatus is provided. The image display apparatus of the present invention includes at least one polarizing plate of the present invention.

### EFFECTS OF THE INVENTION

According to the present invention, a polarizer protective film can be provided, which has high heat resistance, high transparency, high optical characteristics, and high mechanical strength, and is excellent in adhesion with respect to a polarizer. Further, a polarizing plate using the polarizer protective film and a polarizer can be provided, which has high adhesion with respect to the polarizer protective film and the polarizer and is excellent in optical characteristics, excellent in transmittance as viewing angle characteristics, and an image display apparatus of high quality using such a polarizing plate can be provided.

The effect can be expressed by providing a cellulose-based resin layer having a particular thickness on at least one surface of a transparent resin layer containing a (meth)acrylic resin having a lactone ring structure to form a polarizer protective film. In particular, high heat resistance, high transparency, high optical characteristics, and high mechanical strength are expressed by using a (meth)acrylic resin having a lactone ring structure, and the adhesion with respect to a polarizer can be enhanced while the high heat resistance, high transparency, high optical characteristics, and high mechanical strength are kept by providing a cellulose-based resin layer having a particular thickness on the transparent resin layer. A polarizing plate obtained by combining the polarizer protective film with a polarizer is excellent in optical characteristics, in particular, transmittance as viewing angle characteristics.

### BRIEF DESCRIPTION OF THE DRAWINGS

FIG. 1 A cross-sectional view showing an example of a polarizing plate of the present invention.

FIG. 2 A schematic cross-sectional view of a liquid crystal display device according to a preferred embodiment of the present invention.

### DESCRIPTION OF REFERENCE NUMERALS

10 liquid crystal cell
11, 11′ glass substrate
12 liquid crystal layer
13 spacer
20, 20′ retardation film
30, 31′ polarizing plate
31 polarizer
32 adhesive layer
33 cellulose-based resin layer
34 transparent resin layer
35 adhesive layer
36 polarizer protective film
40 light guide plate
50 light source
60 reflector
100 liquid crystal display device
300 polarizer protective film

### BEST MODE FOR CARRYING OUT THE INVENTION

Hereinafter, preferred embodiments of the present invention is described. However, the present invention is not limited thereto.

### A. Polarizer Protective Film

The polarizer protective film of the present invention has a cellulose-based resin layer on at least one surface of a transparent resin layer containing a (meth)acrylic resin having a lactone ring structure.

### A-1. Transparent Resin Layer

The transparent resin layer in the present invention contains a (meth)acrylic resin having a lactone ring structure.

The content of the (meth)acrylic resin having a lactone ring structure in the transparent protective layer in the present invention is preferably 60 to 100% by weight, more preferably 60 to 99% by weight, still more preferably 70 to 97% by weight, and particularly preferably 80 to 95% by weight. In the case where the content is less than 50% by weight, high heat resistance, high transparency, and high mechanical strength originally owned by the (meth)acrylic resin having a lactone ring structure may not be reflected sufficiently.

It is preferred that the above-mentioned (meth)acrylic resin having a lactone ring structure have a high light transmittance, and a low in-plane retardation Δnd a low thickness direction retardation Rth.

The (meth)acrylic resin having a lactone ring structure preferably has a lactone ring structure represented by the following General Formula (1).

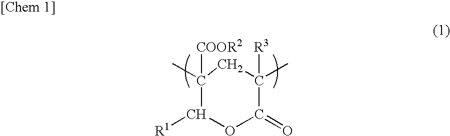

where R¹, R², and R³ each independently represent an organic residue containing a hydrogen atom or 1 to 20 carbon atoms. The organic residues may contain an oxygen atom.

The content ratio of the lactone ring structure represented by General Formula (1) in the structure of the (meth)acrylic resin having a lactone ring structure is preferably 5 to 90% by weight, more preferably 10 to 70% by weight, still more preferably 10 to 60% by weight, and particularly preferably 10 to 50% by weight. When the content ratio of the lactone ring structure represented by General Formula (1) in the structure of the (meth)acrylic resin having a lactone ring structure is smaller than 5% by weight, heat resistance, solvent resistance, and surface hardness may become insufficient. When the content ratio of the lactone ring structure represented by General Formula (1) in the structure of the (meth)acrylic resin having a lactone ring structure is more than 90% by weight, the forming property may become poor.

The (meth)acrylic resin having a lactone ring structure may have a structure other than the lactone ring structure represented by General Formula (1). The structure other than the lactone ring structure represented by General Formula (1) is not particularly limited; however, as a method of producing a (meth)acrylic resin having a lactone ring structure, a polymer structure unit (repeating structure unit) constructed by polymerizing at least one selected from a (meth)acrylate, a hydroxy group-containing monomer, an unsaturated carboxylic acid, and a monomer represented by the following General Formula (2a) as described later is preferred.

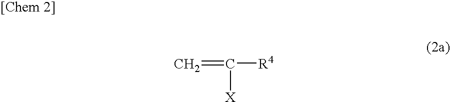

where: R⁴ represents a hydrogen atom or a methyl group; X represents a hydrogen atom, an alkyl group having 1 to 20 carbon atoms, an aryl group, a —CN group, —CO—R⁵ group or a —O—CO—R⁶ group; and R⁵ and R⁶ each represent a hydrogen atom or an organic residue having 1 to 20 carbon atoms.

In the case where the structure other than the lactone ring structure represented by General Formula (1) in the structure of the (meth)acrylic resin having a lactone ring structure is a polymer structure unit (repeating structure unit) constructed by polymerizing (meth)acrylates, the content ratio thereof is preferably 10 to 95% by weight, more preferably 10 to 90% by weight, still more preferably 40 to 90% by weight, and particularly preferably 50 to 90% by weight. In the case of a polymer structure unit (repeating structure unit) constructed by polymerizing a main hydroxy group-containing monomer, the content ratio thereof is preferably 0 to 30% by weight, more preferably 0 to 20% by weight, still more preferably 0 to 15% by weight, and particularly preferably 0 to 10% by weight. In the case of a polymer structure unit (repeating structure unit) constructed by polymerizing unsaturated carboxylic acids, the content ratio thereof is preferably 0 to 30% by weight, more preferably 0 to 20% by weight, still more preferably 0 to 15% by weight, and particularly preferably 0 to 10% by weight. In the case of a polymer structure unit (repeating structure unit) constructed by polymerizing monomers each represented by General Formula (2a), the content ratio is preferably 0 to 30% by weight, more preferably 0 to 20% by weight, still more preferably 0 to 15% by weight, and particularly preferably 0 to 10% by weight.

A method of producing a (meth)acrylic resin having a lactone ring structure is not particularly limited. Preferably, the (meth)acrylic resin having a lactone ring structure is obtained by polymerizing predetermined monomers described below to obtain a polymer (a) having a hydroxyl group and an ester group in the molecule chain, and thereafter, treating the obtained polymer (a) by heat to cause lactone ring condensation in which a lactone ring structure is introduced into the polymer.

In the polymerization step, a polymerization reaction of monomer components containing a monomer represented by the following General Formula (1a) is performed, whereby a polymer having a hydroxyl group and an ester group in the molecule chain is obtained.

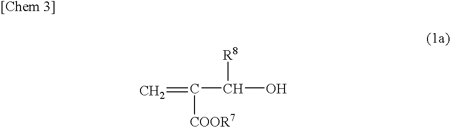

where R⁷ and R⁶ each independently represent a hydrogen atom or an organic residue having 1 to 20 carbon atoms.

Examples of the monomer represented by General Formula (1a) include methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and t-butyl 2-(hydroxymethyl)acrylate. Of those, methyl 2-(hydroxymethyl)acrylate and ethyl 2-(hydroxymethyl)acrylate are preferred and methyl 2-(hydroxymethyl)acrylate is particularly preferred from a viewpoint of high effect of improving heat resistance. They may be used alone or in combination.

The content ratio of the monomer represented by General Formula (1a) in the monomer component used in the polymerization step is preferably 5 to 90% by weight, more preferably 10 to 70% by weight, still more preferably 10 to 60% by weight, and particularly preferably 10 to 50% by weight. When the content ratio of the monomer represented by General Formula (1a) in the monomer component used in the polymerization step is less than 5% by weight, heat resistance, solvent resistance, and surface hardness may be insufficient. When the content ratio of the monomer represented by General Formula (1a) in the monomer component used in the polymerization step is more than 90% by weight, gelling may occur during polymerization and lactone cyclization, and the forming processability of the obtained polymer may be poor.

The monomer component used in the polymerization step may contain a monomer other than the monomer represented by General Formula (1a). The monomer is not particularly limited, and examples thereof include a (meth)acrylate, a hydroxy group-containing monomer, an unsaturated carboxylic acid, and a monomer represented by General Formula (2a). The monomer other than the monomer represented by General Formula (1a) may be used alone or in combination.

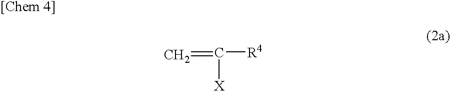

where R⁴ represents a hydrogen atom or a methyl group, X represents a hydrogen atom, an alkyl group having 1 to 20 carbon atoms, an aryl group, —CN group, —CO—R⁵ group, or —O—CO—R⁶ group, R⁵ and R⁶ each represent a hydrogen atom or an organic residue having 1 to carbon atoms.

The (meth)acrylate is not particularly limited as long as the methacrylate is a (meth)acrylate except the monomer represented by the general formula (1a). Examples thereof include: acrylates such as methyl acrylate, ethyl acrylate, n-butyl acrylate, isobutyl acrylate, t-butyl acrylate, cyclohexyl acrylate, and benzyl acrylate; and methacrylates such as methyl methacrylate, ethyl methacrylate, propyl methacrylate, n-butyl methacrylate, isobutyl methacrylate, t-butyl methacrylate, cyclohexyl methacrylate, and benzyl methacrylate. They may be used alone or in combination. Of those, methyl methacrylate is particularly preferred from a viewpoint of excellent heat resistance and transparency.

In the case of using a (meth)acrylate other than the monomer represented by General Formula (1a), the content thereof in the monomer component used in the polymerization step is preferably 10 to 95% by weight, more preferably 10 to 90% by weight, still more preferably 40 to 90% by weight, and particularly preferably 50 to 90% by weight so as to exhibit the effect of the present invention sufficiently.

The hydroxy group-containing monomer is not particularly limited as long as the hydroxy group-containing monomer is a monomer containing a hydroxy group except the monomer represented by General Formula (1a). Examples thereof include: α-hydroxymethyl styrene, α-hydroxyethyl styrene, and 2-(hydroxyalkyl)acrylate such as methyl (2-hydroxyethyl)acrylate; and 2-(hydroxyalkyl)acrylic acid such as 2-(hydroxyethyl)acrylic acid. They may be used alone or in combination.

In the case of using a hydroxy group-containing monomer other than the monomer represented by General Formula (1a), the content thereof in the monomer component used in the polymerization step is preferably 0 to 30% by weight, more preferably 0 to 20% by weight, still more preferably 0 to 15% by weight, and particularly preferably 0 to 10% by weight so as to exhibit the effect of the present invention sufficiently.

Examples of the unsaturated carboxylic acid include acrylic acid, methacrylic acid, crotonic acid, α-substituted acrylic acid, and α-substituted methacrylic acid, and they may be used alone or in combination. Of those, in particular, acrylic acid and methacrylic acid are preferred in terms of allowing the effect of the present invention to be exhibited sufficiently.

In the case of using an unsaturated carboxylic acid, the content ratio of the unsaturated carboxylic acid in the monomer component used in the polymerization step is preferably 0 to 30% by weight, more preferably 0 to 20% by weight, still more preferably 0 to 15% by weight, and particularly preferably 0 to 10% by weight in terms of allowing the effect of the present invention to be exhibited sufficiently.

Examples of the monomer represented by General Formula (2a) include styrene, vinyl toluene, α-methyl styrene, acrylonitrile, methylvinyl ketone, ethylene, propylene, and vinyl acetate. They may be used alone or in combination. Of those, styrene and α-methyl styrene are preferred from a viewpoint of exhibiting sufficiently the effect of the present invention.

In the case of using the monomer represented by General Formula (2a), the content thereof in the monomer component used in the polymerization step is preferably 0 to 30% by weight, more preferably 0 to 20% by weight, still more preferably 0 to 15% by weight, and particularly preferably 0 to 10% by weight so as to exhibit the effect of the present invention sufficiently.

The form of a polymerization reaction for obtaining a polymer having a hydroxyl group and an ester group in the molecular chain by polymerizing monomer components is preferably a polymerization form using a solvent, and particularly preferably a solution polymerization.

Although the polymerization temperature and the polymerization time vary depending upon the kind, the use ratio, and the like of monomers to be used, the polymerization temperature and the polymerization time are preferably 0 to 150° C. and 0.5 to 20 hours, and more preferably 80° C. to 140° C. and 1 to 10 hours.

In the case of the polymerization form using a solvent, the polymerization solvent is not particularly limited. Examples of the polymerization solvent include aromatic hydrocarbon-based solvents such as toluene, xylene, and ethylbenzene; ketone-based solvents such as methyl ethyl ketone and methyl isobutyl ketone; and ether solvents such as tetrahydrofuran. They may be used alone or in combination. Further, when the boiling point of the solvent to be used is too high, a remaining volatile component in finally obtained (meth)acrylic resin having a lactone ring structure becomes large, so the boiling point is preferably 50 to 200° C.

A polymerization initiator may be added upon the polymerization as required. The polymerization initiator is not particularly limited. Examples thereof include: organic peroxides such as cumene hydroperoxide, diisopropyl benzene hydroperoxide, di-t-butyl peroxide, lauroyl peroxide, benzoyl peroxide, t-butylperoxyisopropyl carbonate, and t-amylperoxy-2-ethylhexanoate; azo compounds such as 2,2′-azobis(isobutyronitrile), 1,1′-azobis(cyclohexane carbonitrile), and 2,2′-azobis(2,4-dimethylvaleronitrile). They may be used alone or in combination. Use amount of the polymerization initiator is not particularly limited and may be set appropriately depending on the combination of the monomers to be used or reaction conditions.

For polymerization, in order to suppress the gelling of a reaction solution, it is preferred to control the concentration of the polymer generated in the polymerization reaction mixture to 50% by weight or less. Specifically, in the case where the concentration of the generated polymer in the polymerization reaction mixture exceeds 50% by weight, it is preferred to control the concentration of the polymer to 50% by weight or less by appropriately adding a polymerization solvent to the polymerization reaction mixture. The concentration of the generated polymer in the polymerization reaction mixture is more preferably 45% by weight or less, and still more preferably 40% by weight or less. When the concentration of the polymer in the polymerization reaction mixture is too low, the productivity decreases, so the concentration of the generated polymer in the polymerization reaction mixture is preferably 10% by weight or more, and more preferably 20% by weight or more.

There is no particular limit to the form of appropriately adding a polymerization solvent to the polymerization reaction mixture, and the polymerization solvent may be added continuously or intermittently. By controlling the concentration of the generated polymer in the polymerization reaction mixture in this manner, the gelling of the reaction solution can be suppressed sufficiently. In particular, even in the case where the ratio of a hydroxyl group and an ester group in the molecular chain is increased so as to increase the containing ratio of a lactone ring to enhance heat resistance, the gelling can be suppressed sufficiently. The polymerization solvent to be added may be the same kind of a solvent as that used for initial charging of the polymerization reaction or may be a different kind of a solvent. However, it is preferred to use the same kind of a solvent as that used for initial charging of the polymerization reaction. Further, the polymerization solvent to be added may be one kind of a solvent or a mixed solvent of two or more kinds.

The polymerization reaction mixture obtained at the time when the polymerization step is completed generally contains a solvent other than the obtained polymer. However, it is not necessary to remove the solvent completely to take out the polymer in a solid state, and it is preferred to introduce the polymerization reaction mixture into the following lactone condensation step in a state where the mixture contains a solvent. Further, if required, after the mixture is taken out in a solid state, an appropriate solvent may be added again to the following lactone ring condensation step.

The polymer obtained in the polymerization step is a polymer (a) having a hydroxyl group and an ester group in the molecular chain, and the weight average molecular weight of the polymer (a) is preferably 1,000 to 2,000,000, more preferably 5,000 to 1,000,000, still more preferably 10,000 to 500,000, and particularly preferably 50,000 to 500,000. The polymer (a) obtained in the polymerization step is treated by heat in the following lactone ring condensation step, and the lactone ring structure is introduced into the polymer, whereby a (meth)acrylic resin having a lactone ring structure is obtained.

The reaction for introducing a lactone ring structure into the polymer (a) is a reaction in which a hydroxyl group and an ester group present in the molecular chain of the polymer (a) are subjected to ring condensation by heating to generate a lactone ring structure, and alcohol is generated as a by-product by the ring condensation. The lactone ring structure is formed in a molecular chain of the polymer (main skeleton of the polymer), whereby high heat resistance is provided. When the reactivity of the ring condensation reaction introducing a lactone ring structure is insufficient, heat resistance is not be enhanced sufficiently, and the condensation reaction occurs in the course of forming by the heat treatment during forming, with the result that generated alcohol may be present as bubbles or silver streaks in a formed product.

The (meth)acrylic resin having a lactone ring structure obtained in the lactone ring condensation step preferably has a lactone ring structure represented by the following General Formula (1).

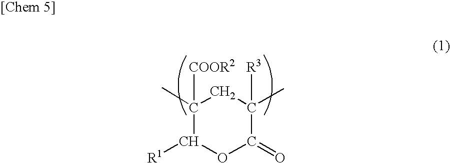

where R¹, R², and R³ each independently represent an organic residue containing a hydrogen atom or 1 to 20 carbon atoms. The organic residues may contain an oxygen atom.

The method of treating the polymer (a) by heat is not particularly limited, and a known method can be used. For example, the polymerization reaction mixture containing a solvent obtained in the polymerization step may be treated by heat as it is. Further, in the presence of a solvent, the polymerization reaction mixture may be treated by heat using a cyclization catalyst, if required. Further, the polymerization reaction mixture can also be treated by heat using a heating furnace or a reaction apparatus having a vacuum device or a devolatilizing device for removing a volatilized component, an extruder having a devolatilizing device, or the like.

For causing a ring condensation reaction, another thermoplastic resin may coexist in addition to the polymer (a). Further, for causing a ring condensation reaction, if required, an esterification catalyst or ester interchange catalyst such as p-toluene sulfonic acid generally used as a catalyst of the ring condensation reaction may be used, or organic carboxylic acids such as acetic acid, propionic acid, benzoic acid, acrylic acid, and methacrylic acid may be used as a catalyst. As shown in JP 61-254608 A and JP 61-261303 A, a basic compound, an organic carboxylate, a carbonate, or the like may be used.

For causing the ring condensation reaction, it is preferred to use an organic phosphorus compound as a catalyst as shown in JP 2001-151814 A. By using the organic phosphorus compound as a catalyst, the ring condensation reactivity can be enhanced, and the coloring of a polymer containing a lactone ring to be obtained can be reduced largely. Further, by using the organic phosphorus compound as a catalyst, the decrease in a molecular weight that can occur in the case of using a devolatilizing step described later concurrently can be suppressed, and excellent mechanical strength can be provided.

Although the use amount of a catalyst used for the ring condensation reaction is not particularly limited, the use amount is preferably 0.001 to 5% by weight, more preferably 0.01 to 2.5% by weight, still more preferably 0.01 to 1% by weight, and particularly preferably 0.05 to 0.5% by weight with respect to the polymer (a). When the use amount of a catalyst is less than 0.001% by weight, there is a possibility that the reactivity of the ring condensation reaction may not be enhanced sufficiently. On the other hand, when the use amount of the catalyst exceeds 5% by weight, there is a possibility that coloring may be caused and melt forming may be unlikely to be performed due to the cross-linking of the polymer.

The timing for adding the catalyst is not particularly limited, and the catalyst may be added in an initial reaction period, in the course of the reaction, or in both periods.

It is preferred that the ring condensation reaction is performed in the presence of a solvent, and the devolatilizing step is used concurrently in the ring condensation reaction. In this case, the devolatilizing step may be used concurrently throughout the ring condensation reaction, or the devolatilizing step may be used concurrently in a part of a process without being used throughout the entire process of the ring condensation reaction. In the method of using the devolatilizing step concurrently, alcohol generated as a by-product in the ring condensation reaction is forcefully devolatilized to be removed, so the equilibrium of the reaction becomes advantageous to the generation side.

The devolatilizing step refers to the step of removing a volatilized component such as a solvent or a remaining monomer, and alcohol generated as a by-product by the ring condensation reaction introducing a lactone ring structure under reduced pressure and heating as required. When the removal treatment is insufficient, the remaining volatilized component in the generated resin becomes large, and there arise problems in that coloring is caused due to the deformation during forming, forming defects such as bubbles and silver streaks may be caused, and the like.

In the case of using the devolatilizing step concurrently throughout the entire ring condensation reaction, devices to be used are not particularly limited. However, in order to carry out the present invention more efficiently, it is preferred to use a devolatilizing device including a heat exchanger and a devolatilizing tank, a extruder with a vent, or the devolatilizing device and the extruder arranged in series, and it is more preferred to use a devolatilizing device including a heat exchanger and a devolatilizing tank or an extruder with a vent.

The reaction treatment temperature in the case of using the devolatilizing device including a heat exchanger and a devolatilizing tank is preferably in a range of 150° C. to 350° C., and more preferably in a range 200° C. to 300° C. When the reaction treatment temperature is lower than 150° C., the ring condensation reaction becomes insufficient, and the remaining volatilized component may increase. When the reaction treatment temperature is higher than 350° C., coloring and decomposition may occur.

The pressure at a time of reaction treatment in the case of using a devolatilizing device including a heat exchanger and a devolatilizing tank is preferably in a range of 931 to 1.33 hpa (700 to 1 mmHg), and more preferably in a range of 798 to 66.5 hpa to 50 mmHg). When the pressure is higher than 931 hpa, there is a problem that a volatilized component including alcohol is likely to remain. When the pressure is lower than 1.33 hpa, industrial operation becomes difficult.

In the case of using the extruder with a vent, one or a plurality of vents may be used. However, it is preferred that the extruder have a plurality of vents.

The reaction treatment temperature in the case of using the extruder with a vent is preferably in a range of 150° C. to 350° C., and more preferably in a range of 200° C. to 300° C. When the temperature is lower than 150° C., the ring condensation reaction may become insufficient to increase the remaining volatilized component. When the temperature is higher than 350° C., coloring and decomposition may occur.

The pressure at a reaction treatment in the case of using the extruder with a vent is preferably in a range of 931 to 1.33 hpa (700 to 1 mmHg), and more preferably in a range of 798 to 13.3 hpa (600 to 10 mmHg). When the pressure is higher than 931 hpa, there is a problem that a volatilized component including alcohol is likely to remain. When the pressure is lower than 1.33 hpa, industrial operation becomes difficult.

In the case of using the devolatilizing step concurrently throughout the entire ring condensation reaction, the physical properties of a (meth)acrylic resin having a lactone ring structure to be obtained may be degraded under strict heat treatment conditions as described later. Therefore, it is preferred that the devolatilizing step be performed using an extruder with a vent under conditions that are as mild as possible using the catalyst of a dealcoholization reaction.

Further, in the case of using the devolatilizing step concurrently throughout the entire ring condensation reaction, the polymer (a) obtained in the polymerization step is preferably introduced into a ring condensation reaction apparatus system together with a solvent. In this case, if required, the polymer (a) may be allowed to pass through the reaction device system such as an extruder with a vent again.

The devolatilizing step may be performed only in a part of the process without being used throughout the entire process of the ring condensation reaction. For example, the apparatus used for producing the polymer (a) is further heated, and the depolarizing step is partially used concurrently, if required, to allow the ring condensation reaction to proceed to some degree. Then, the ring condensation reaction using the depolarizing step concurrently is performed to complete the reaction.

In the case where the devolatilizing step is used concurrently throughout the entire ring condensation reaction as described above, for example, when the polymer (a) is treated by heat at about 250° C. or a higher temperature using a biaxial extruder, a partial decomposition or the like is caused due to the difference in thermal hysteresis before the ring condensation reaction is caused, with the result that the physical properties of the (meth)acrylic resin having a lactone ring structure to be obtained may be degraded. Thus, it is preferred that the ring condensation reaction be previously allowed to proceed to some degree before the ring condensation reaction using the devolatilizing step concurrently is caused, because the reaction conditions in the latter half can be ameliorated, and the degradation in physical properties of the (meth)acrylic resin having a lactone ring structure to be obtain can be suppressed. A particularly preferred form is that the devolatilizing step is started after the elapse of a time from the start of the ring condensation reaction, that is, the ring condensation reactivity is enhanced to some degree by subjecting a hydroxyl group and an ester group present in the molecular chain of the polymer (a) obtained in the polymerization step to the ring condensation reaction previously, and then, the ring condensation reaction using the devolatilizing step concurrently is performed. Specifically, for example, the ring condensation reaction is previously allowed to proceed to a reactivity to some degree in the presence of a solvent using a boiler-type reactor, and thereafter, the ring condensation reaction is completed using a reactor with a devolatilizing device such as a devolatilizing device with a heat exchanger and a devolatilizing tank, and an extruder with a vent. Particularly in the case of this form, it is more preferred that a catalyst for the ring condensation reaction be present.

As described above, a method of subjecting a hydroxyl group and an ester group present in the molecular chain of the polymer (a) obtained in the polymerization step to the ring condensation reaction previously to enhance the ring condensation reactivity to some degree, and then, performing the ring condensation reaction using the devolatilizing step concurrently is a preferred form for obtaining a (meth)acrylic resin having a lactone ring structure in the present invention. Due to this form, a (meth)acrylic resin having a lactone ring structure, which has a higher glass transition temperature and an enhanced ring condensation reactivity and is excellent in heat resistance is obtained. In this case, as a guide for the ring condensation reactivity, the weight decrease ratio between 150° C. and 300° C. in a dynamic TG measurement described later is preferably 2% or less, more preferably 1.5% or less, and still more preferably 1% or less.

There is no particular reactor that can be adopted in the ring condensation reaction that is effected previously before the ring condensation reaction using the devolatilizing step concurrently. However, an autoclave, a boiler-type reactor, a devolatilizing device including a heat exchanger and a devolatilizing tank are preferably exemplified, and further, an extruder with a vent suitable for the ring condensation reaction using the devolatilizing step concurrently can also be used. An autoclave and a boiler-type reactor are more preferred. However, even when the reactor such as an extruder with a vent is used, the ring condensation reaction can be performed in the same state as the reaction state in an autoclave and a boiler-type reactor by making vent conditions mild, using no vent, adjusting temperature conditions, barrel conditions, screw shape, screw operation conditions, and the like.

For the ring condensation reaction that is performed previously before the ring condensation reaction using the devolatilizing step concurrently, preferably, there are (i) a method of subjecting a mixture containing the polymer (a) obtained in the polymerization step and a solvent with a catalyst added to a heat reaction; (ii) a method of subjecting the mixture to a heat reaction without using a catalyst; and a method of performing (i) or (ii) under a pressing.

The term “mixture containing the polymer (a) and a solvent” introduced into the ring condensation reaction in the lactone ring condensation step means that the polymerization reaction mixture obtained in the polymerization step may be used as it is or that a solvent is once removed and a solvent suitable for the ring condensation reaction may be added again.

The solvent that can be added again in the ring condensation reaction that is performed previously before the ring condensation reaction using the devolatilizing step concurrently is not particularly limited, and examples thereof include aromatic hydrocarbons such as toluene, xylene, and ethylbenzene; ketones such as methyl ethyl ketone and methyl isobutyl ketone; chloroform; DMSO; and tetrahydrofuran. The same kind of a solvent as the one which can be used in the polymerization step is preferred.

Examples of the catalyst added in the method (i) include a generally used esterification catalyst or ester interchange catalyst such as p-toluene sulfonic acid, a basic compound, an organic carboxylate, and a carbonate. In the present invention, the organic phosphorus compound can be used preferably. The timing for adding the catalyst is not particularly limited, and the catalyst may be added in an initial reaction period, in the course of the reaction, or in both periods. The amount of the catalyst to be added is not particularly limited, and is preferably 0.001 to 5% by weight, more preferably 0.01 to 2.5% by weight, still more preferably 0.01 to 1% by weight, and particularly preferably 0.05 to 0.5% by weight with respect to the weight of the polymer (a). The heating temperature and the heating time in the method (i) are not particularly limited, and the heating temperature is preferably room temperature or higher, more preferably 50° C. or higher, and the heating time is preferably 1 to 20 hours, more preferably 2 to 10 hours. When the heating temperature is low or the heating time is short, the ring condensation reactivity may decrease. On the other hand, when the heating time is too long, coloring and decomposition of the resin may occur.

As the method (ii), there are a method of heating the polymerization reaction mixture obtained in the polymerization step as it is using a pressure-resistant boiler and the like. The heating temperature is preferably 100° C. or higher, more preferably 150° C. or higher. The heating time is preferably 1 to 20 hours, more preferably 2 to 10 hours. When the heating temperature is low or the heating time is short, the ring condensation reactivity may decrease. On the other hand, when the heating time is too long, coloring and decomposition of the resin may occur.

There is no problem even if the methods (i) and (ii) are performed under a pressing, depending upon the conditions.

In the ring condensation reaction that is performed previously before the ring condensation reaction using the devolatilizing step concurrently, even if a part of a solvent is volatilized naturally during a reaction, there is no problem.

The weight decrease ratio between 150° C. and 300° C. in a dynamic TG measurement at the end of the ring condensation reaction that is performed previously before the ring condensation reaction using the devolatilizing step concurrently, i.e., immediately before the start of the devolatilizing step is preferably 2% or less, more preferably 1.5% or less, and still more preferably 1% or less. When the weight decrease ratio is higher than 2%, even if the ring condensation reaction using the devolatilizing step concurrently is performed subsequently, the ring condensation reactivity does not increase to a sufficiently high level, and the physical properties of a polymer containing a lactone ring to be obtained may be degraded. When the ring condensation reaction is performed, another thermoplastic resin may be allowed to coexist in addition to the polymer (a).

In the case of enhancing the ring condensation reactivity to some degree by subjecting a hydroxyl group and an ester group present in the molecular chain of the polymer (a) obtained in the polymerization step to the ring condensation reaction previously, and subsequently, causing the ring condensation reaction using the devolatilizing step concurrently, the polymer obtained in the ring condensation reaction that is performed previously (polymer in which at least part of a hydroxyl group and an ester group present in the molecular chain is subjected to the ring condensation reaction) and a solvent may be introduced, as they are, into the ring condensation reaction using the devolatilizing step concurrently. Alternatively, the polymer and the solvent may be introduced into the ring condensation reaction using the devolatilizing step concurrently after performing another treatment, if required, in which the polymer (polymer in which at least part of a hydroxyl group and an ester group present in a molecular chain is subjected to the ring condensation reaction) is isolated, and a solvent is added again.

The devolatilizing step is not necessarily required to be completed simultaneously with the ring condensation reaction, and may be completed after an elapse of a time from the completion of the ring condensation reaction.

The mass average molecular weight (which may be referred to as weight average molecular weight) of the (meth)acrylic resin having a lactone ring structure is preferably 1,000 to 2,000,000, more preferably 5,000 to 1,000,000, still more preferably 10,000 to 500,000, and particularly preferably 50,000 to 500,000. When the mass average molecular weight is out of the above-mentioned range, the effects of the present invention may not be exhibited sufficiently.

In the (meth)acrylic resin having a lactone ring structure, the weight decrease ratio between 150° C. and 300° C. in a dynamic TG measurement is preferably 1% or less, more preferably 0.5% or less, and still more preferably 0.3% or less.

The (meth)acrylic resin having a lactone ring structure has a high ring condensation reaction. Therefore, the defects that bubbles and silver streaks are present in a formed product obtained by forming the (meth)acrylic resin can be avoided. Further, the lactone ring structure is introduced into a polymer sufficiently due to a high ring condensation reactivity. Therefore, the (meth)acrylic resin having a lactone ring structure to be obtained has sufficiently high heat resistance.

It is preferred that the (meth)acrylic resin having a lactone ring structure have a coloring degree (YI) in 15% by weight of a chloroform solution of preferably 6 or less, more preferably 3 or less, still more preferably 2 or less, and most preferably 1 or less. When the coloring degree (YI) exceeds 6, transparency is impaired due to the coloring, which makes it impossible to use the resin for the intended application.

In the (meth)acrylic resin having a lactone ring structure, the 5%-weight decrease temperature in thermogravimetric analysis (TG) is preferably 280° C. or higher, more preferably 290° C. or higher, and still more preferably 300° C. or higher. The 5%-weight decrease temperature in thermogravimetric analysis (TG) is an index for heat stability (heat resistance). When the 5%-weight decrease temperature in thermogravimetric analysis (TG) is lower than 280° C., sufficient heat stability (heat resistance) may not be exhibited.

The glass transition temperature (Tg) of the (meth)acrylic resin having a lactone ring structure is preferably 115° C. or higher, more preferably 125° C. or higher, still more preferably 130° C. or higher, particularly preferably 135° C. or higher, and most preferably 140° C. or higher. When the Tg is 115° C. or higher, for example, in a case where the (meth)acrylic resin having such a Tg is finally incorporated in a polarizing plate, the polarizing plate is likely to have excellent durability. The upper limit value of the Tg of the (meth)acrylic resin having a lactone ring structure is not particularly limited. However, it is preferably 150° C. or lower in view of exhibiting additionally the effect of the present invention.

The total amount of the remaining volatized component contained in the (meth)acrylic resin having a lactone ring structure is preferably 5,000 ppm or less, and more preferably 2,000 ppm or less. When the total amount of the remaining volatilized component is more than 5,000 ppm, the resin may be colored or may generate bubbles due to the alteration during forming, which causes the defects of forming such as silver streaks.

Regarding the (meth)acrylic resin having a lactone ring structure, the total light transmittance measured by a method pursuant to ASTM-D-1003 of a molding obtained by injection molding is preferably 85% or higher, more preferably 88% or higher, and still more preferably 90% or higher. The total light transmittance is an index of transparency. When the total light transmittance is less than 85%, the transparency decreases, which may make it impossible to use the resultant polarizing plate for the intended application.

The transparent resin layer in the present invention may contain another thermoplastic resin other than the (meth)acrylic resin having a lactone ring structure. The kind of another thermoplastic resin in the present invention is not limited as long as it has a glass transition temperature of 120° C. or higher, a retardation per 100 μm in a plane direction of 20 nm or less, and performance of a total light transmittance of 85% or more, when being blended with the (meth)acrylic resin having a lactone ring structure to form a film. However, the thermoplastic resin that is compatible thermodynamically is preferred in terms of the enhancement of transparency and mechanical strength.

Examples of the other thermoplastic resin include: olefin-based polymers such as polyethylene, polypropylene, an ethylene-propylene copolymer, and poly(4-methyl-1-pentene); halogen-containing polymers such as vinyl chloride and a vinyl chloride resin; acrylic polymers such as polymethyl methacrylate; styrene-based polymers such as polystyrene, a styrene-methyl methacrylate copolymer, a styrene-acrylonitrile copolymer, a acrylonitrile-butadiene-styrene block copolymer; polyesters such as polyethylene terephthalate, polybutylene terephthalate, and polyethylene naphthalate; polyamides such as nylon 6, nylon 66, and nylon 610; polyacetal; polycarbonate; polyphenylene oxide; polyphenylene sulfide; polyether ether ketone; polysulfone; polyether sulfone; polyoxybenzylene; polyamide imide; and rubber polymers such as a ABS resin obtained by blending a polybutadiene-based rubber and acrylic rubber, and an ASA resin. The rubber polymer preferably has, on the surface, a graft portion with a composition, which is compatible with the lactone ring polymer of the present invention, and further, the average particle size of the rubber polymer is preferably 100 nm or less and more preferably 70 nm or less from the viewpoint of enhancing the transparency when the polymer is formed into a film.

As the thermoplastic resin that is thermodynamically compatible with the (meth)acrylic resin having a lactone ring structure, a polymer containing a cyanized vinyl-based monomer unit and an aromatic vinyl-based monomer unit, specifically, an acrylonitrile-styrene-based copolymer, a polyvinyl chloride resin, or a polymer containing 50% by weight or more of methacrylate may be used. Of those, if the acrylonitril-styrene-based copolymer is used, a transparent resin layer having a glass transition temperature of 120° C. or higher, a retardation per 100 μm in a plane direction of 20 nm or less, and performance of a total light transmittance of 85% or more can be obtained easily.

When the transparent resin layer of the present invention contains another thermoplastic resin, the content ratio of the (meth)acrylic resin having a lactone ring structure and another thermoplastic resin is preferably 60 to 99:1 to 40% by weight, more preferably 70 to 97:3 to 30% by weight, and still more preferably 80 to 95:5 to 20% by weight. When the content ratio of the (meth)acrylic resin having a lactone ring structure in the transparent resin layer is less than 60% by weight, the effects of the present invention may not be exhibited sufficiently.

The transparent resin layer in the present invention may contain another additive. Examples of another additive include antioxidants such as a hindered phenol-based antioxidant, a phosphorus-based antioxidant, and a sulfur-based antioxidant; stabilizers such as a light fastness stabilizer, a weather resistant stabilizer, and a heat stabilizer; reinforcing materials such as glass fibers and carbon fibers; UV-absorbers such as phenyl salicylate, (2,2′-hydroxy-5-methylphenyl)benzotriazole, and 2-hydroxybenzophenone; near infrared ray absorbers; flame retardants such as tris(dibromopropyl)phosphate, triallyl phosphate, and antimony oxide; antistatic agents such as an anionic, cationic, and nonionic surfactants; colorants such as an inorganic pigment, an organic pigment, and dyes; organic fillers and inorganic fillers; resin modifiers; organic fillers and inorganic fillers; plasticizers; lubricants; antistatic agents; and flame retardants.

The content ratio of another additive in the transparent resin layer in the present invention is preferably 0 to 5% by weight, more preferably 0 to 2% by weight, and still more preferably 0 to 0.5% by weight.

The transparent resin layer in the present invention can function as an optical film capable of exhibiting the properties depending upon various kinds of optical applications sufficiently.

The glass transition temperature of the transparent resin layer in the present invention is preferably 120° C. or higher, more preferably 125° C. or higher, and still more preferably 130° C. or higher.

The thickness of the transparent resin layer in the present invention is preferably 1 μm or more to less than 500 μm, and more preferably 10 μm or more to less than 300 μm. The transparent resin layer having a thickness of less than 1 μm may have insufficient strength, and is likely to be ruptured when being stretched.

In the transparent resin layer in the present invention, the tensile strength measured based on ASTM-D-882-61T is preferably 10 MPa or more to less than 100 MPa, and more preferably 30 MPa or more to less than 100 MPa. In the case where the tensile strength is less than 10 MPa, sufficient mechanical strength may not be expressed. When the tensile strength exceeds 100 MPa, the processability may be degraded.

In the transparent resin layer in the present invention, the elongation measured based on ASTM-D-882-61T is preferably 1% or more, and more preferably 3% or more. In general, the upper limit is preferably 100% or less although not limited particularly. In the case where the elongation is less than 1%, the transparent resin layer may lack ductility.

In the transparent resin layer in the present invention, the elastic modulus in tension measured based on ASTM-D-882-61T is preferably 0.5 GPa or more, more preferably 1 GPa or more, and still more preferably 2 GPa or more. The elastic modulus in tension generally is preferably 20 GPa or less although not limited particularly. In the case where the elastic modulus in tension is less than 0.5 GPa, the transparent resin layer may not express sufficient mechanical strength.

It is preferred that the transparent resin layer of the present invention have an in-plane retardation Δnd of 3.0 nm or less, a thickness direction retardation Rth of 10.0 nm or less, and a tear strength of 2.0 N/mm or more. The in-plane retardation Δnd, the thickness direction retardation Rth, and the tear strength are in those ranges, to thereby satisfy excellent optical characteristics and excellent mechanical strength.

In the transparent resin layer in the present invention, the in-plane retardation Δnd is preferably as small as possible, and is preferably 2.0 nm or less, more preferably 1.5 nm or less, and still more preferably 1.0 nm or less. When the above-mentioned in-plane retardation Δnd exceeds 3.0 nm, there is a possibility that the effects of the present invention, in particular, excellent optical characteristics may not be exhibited. The thickness direction retardation Rth is preferably as small as possible, and is preferably 7.0 nm or less, more preferably 5.0 nm or less, and still more preferably 3.0 nm or less. When the above-mentioned thickness direction retardation Rth exceeds 10.0 nm, the effects of the present invention, in particular, excellent optical characteristics may not be exhibited.

The transparent resin layer in the present invention preferably has excellent mechanical strength. The tear strength is preferably 2.1 N/mm or more, more preferably 2.2 N/mm or more, still more preferably 2.3 N/mm or more, particularly preferably 2.4 N/mm or more, and most preferably 2.5 N/mm or more. The maximum range of the tear strength is not particularly limited, but is preferably 5.0 N/mm or more in terms of formability. In a case where the tear strength is out of the above-mentioned range, the excellent mechanical strength may not be exhibited.

In the transparent resin layer in the present invention, the moisture permeability is preferably as low as possible, and is preferably 100 g/m²·24 hr or less, and more preferably 60 g/m²·24 hr or less. When the above-mentioned moisture permeability exceeds g/m²·24 hr, the moisture resistance may be degraded.

The haze representing optical transparency of the transparent resin layer in the present invention is preferably as low as possible, and is preferably 5% or less, more preferably 3% or less, and still more preferably 1.5% or less, and particularly preferably 1% or less. When the haze is 5% or less, a film can be visually provided with satisfactory clear feeling. When the haze is 1.5% or less, even if the polarizer protective film is used as a lighting member such as a window, both visibility and lighting property are obtained, and even if the polarizer protective film is used as a front plate of a display device, display contents can be visually recognized satisfactorily. Thus, the polarizer protective film with such a haze has a high industrial use value.

In the transparent resin layer in the present invention, the total light transmittance measured by the method in accordance with ASTM-D-1003 is preferably as high as possible, and is preferably 85% or more, more preferably 88% or more, and still more preferably 90% or more. When the total light transmittance is less than 85%, the transparency decreases, and the transparent resin layer may not be used for the intended application.

The method of producing a transparent resin layer in the present invention is not particularly limited. For example, a transparent resin layer can be produced by mixing a (meth)acrylic resin having a lactone ring structure, another thermoplastic resin, another additive, and the like by a conventionally known mixing method to form a thermoplastic resin composition previously. As the method of producing a thermoplastic resin composition, for example, a method of blending components with a mixer such as an omnimixer and thereafter, extruding and kneading the obtained mixture. In this case, a kneader used for extrusion and kneading is not particularly limited, and for example, a conventionally known kneader such as a uniaxial extruder and a biaxial extruder, or a pressure kneader can be used.

As the method of forming a film, there are known film forming methods such as solution casting (solution casting method), a melt extrusion method, calendaring, and compression forming. Of those, the solution casting (solution casting method), and the melt extrusion method are preferred. At this time, the thermoplastic resin composition that is previously extruded and kneaded as described above may be used, or a polymer containing a lactone ring, another thermoplastic resin, another additive, and the like are dissolved separately in solutions to form a uniform mixed solution, and thereafter, the mixed solution may be subjected to a film forming step such as solution casting (solution casting method) and a melt extrusion method.

Examples of the solvent used in the solution casting (solution casting method) include: chlorine-based solvents such as chloroform and dichloromethane; aromatic solvents such as toluene, xylene, benzene, and mixed solvents thereof; alcohol-based solvents such as methanol, ethanol, isopropanol, n-butanol, and 2-butanol; methyl cellosolve, ethyl cellosolve, butyl cellosolve, dimethyl formamide, dimethyl sulfoxide, dioxane, cyclohexanone, tetrahydrofuran, acetone, methylethylketone (MEK), ethylacetate, and diethylether. They may be used alone or in combination.

Examples of the apparatus for conducting the solution casting method include drum-type casting machines, band-type casting machines, and spin coaters.

Examples of the melt extrusion method include a T-die method and an inflation method. The film forming temperature is preferably 150° C. to 350° C., and more preferably 200° C. to 300° C.

In the case of forming a film by the T-die method, a T-die is attached to a tip end of a known uniaxial extruder or biaxial extruder, and a film extruded in a film shape is taken up to obtain a roll-shaped film. At this time, the temperature of a take-up roll is adjusted appropriately to give stretching in an extrusion direction, whereby the film can also be stretched uniaxially. Further, by adding the step of stretching a film in a direction perpendicular to the extrusion direction, the steps such as sequential biaxial stretching and simultaneous biaxial stretching can also be added.

The transparent resin layer in the present invention may be an unstretched film or a stretched film. In the case of stretching the transparent resin layer, the transparent resin layer may be a uniaxially stretched film or a biaxially stretched film. In the case of forming the transparent resin layer into a biaxially stretched film, the transparent resin layer may be a simultaneously biaxially stretched film or a sequentially biaxially stretched film. In the case of forming the transparent resin layer into a biaxially stretched film, the film performance is enhanced with increased mechanical strength. The (meth)acrylic resin having a lactone ring structure in the present invention can suppress the increase in a retardation even if the (meth)acrylic resin is stretched with another thermoplastic resin mixed therewith, whereby optical isotropy can be kept.

The stretching temperature is preferably in the vicinity of a glass transition temperature of a thermoplastic resin composition of a film material, and specifically, the stretching is performed at preferably (glass transition temperature−30)° C. to (glass transition temperature+100)° C., and more preferably (glass transition temperature−20)° C. to (glass transition temperature+80)° C. When the stretching temperature is lower than (glass transition temperature−30)° C., a sufficient stretching magnification may not be obtained. When the stretching temperature is higher than (glass transition temperature+100)° C., the flow of a resin occurs, with the result that stable stretching may not be performed.

The stretching magnification defined in an area ratio is preferably in a range of 1.1 to 25 times, and more preferably in a range of 1.3 to 10 times. When the stretching magnification is smaller than 1.1 times, the ductility involved in stretching may be insufficient. When the stretching magnification is more than 25 times, the effect of enhancing a stretching ratio is not recognized.

The stretching speed (one direction) is preferably in a range of 10 to 20,000%/minute, and more preferably in a range of 100 to 10,000%/minute. When the stretching speed is lower than 10%/minute, it takes a time for obtaining a sufficient stretching magnification, which may increase a production cost. When the stretching speed is higher than 20,000%/minute, a stretched film may be ruptured.

In order to stabilize the optical isotropy and mechanical properties of a film, heat treatment (annealing) and the like can be performed after a stretching treatment.

As the optical characteristics of the transparent resin layer in the present invention, the magnitude of a retardation in front and thickness directions becomes a problem. Therefore, it is preferred that a material (resin composition) forming a film before stretching contain a retardation reducing agent. As the retardation reducing agent, for example, a polymer containing styrene such as an acrylonitrile-styrene copolymer is preferred. The adding amount of the retardation reducing agent is preferably 30% by weight or less, more preferably 25% by weight or less, and still more preferably 20% by weight or less with respect to the (meth)acrylic resin. In the case where the retardation reducing agent is added in an amount exceeding the above-mentioned range, visible light is scattered and transparency is impaired, so the properties of the transparent resin layer may be lost.

The transparent resin layer in the present invention can be used while being laminated on another base. For example, the transparent resin layer can also be laminated on a base of glass, polyolefin resin, an ethylene vinylidene copolymer to be a high barrier layer, or polyester by multi-layer extrusion forming or multi-layer inflation molding, including an adhesive resin layer. In the case where heat fusion is high, the adhesive layer may be omitted.

In addition to the application as a member of a polarizer protective film, the transparent resin layer in the present invention can be used while being laminated on, for example, an architectural lighting member such as a window and a carport roof material, a lighting member for a vehicle such as a window, an agricultural lighting member such as a greenhouse, an illumination member, or a display member such as a front filter. Further, the transparent resin layer can be used while being laminated on a housing of a household electrical appliance, an interior member in a vehicle, an architectural material for an interior, wall paper, a decorative laminated sheet, an entrance door, a window frame, a baseboard, or the like, which is covered with a (meth)acrylic resin film conventionally.

### A-2. Cellulose-Based Resin Layer

The cellulose-based resin layer in the present invention is provided on at least one surface of the transparent resin layer. By providing the cellulose-based resin layer, the adhesion between the polarizer protective film of the present invention and the polarizer can be enhanced. The method for forming the cellulose-based resin layer in the present invention is not particularly limited. Preferably, a cellulose-based resin solution formed by dissolving a cellulose-based resin in a solvent is applied to at least one surface of the transparent resin layer, followed by drying, whereby the cellulose-based resin layer is formed.

The cellulose-based resin is not particularly limited. A preferred example includes a cellulose-ester-based resin. An example of the cellulose-ester-based resin includes an aliphatic acid ester of cellulose having hydrolysability, and a lower aliphatic acid ester of cellulose is preferred. The lower aliphatic acid refers to aliphatic acid having a carbon number of 6 or less.

Specific examples of the lower aliphatic acid ester of cellulose include single aliphatic esters such as cellulose diacetate, cellulose triacetate, cellulose propionate, and cellulose butyrate; mixed aliphatic acid esters such as cellulose acetate propionate and cellulose acetate butyrate, and a mixture thereof. Of those, cellulose acetate propionate and cellulose acetate butyrate are preferred. This is because, in the case of using a method of forming a solution of an cellulose ester into a cellulose ester layer on the transparent resin layer, a solvent can be selected from a relatively wide range, and surface improvement by hydrolysis after providing the layer becomes easy.

It is preferred that a solvent used for obtaining a cellulose-based resin solution be capable of dissolving or dispersing a cellulose-based resin to generate a flowing liquid and have affinity of being cast on the transparent resin layer in the present invention. Examples of the solvent include acetone, methyl ethyl ketone, methyl isobutyl ketone, methyl acetate, ethyl acetate, isopropyl acetate, n-propyl acetate, isobutyl acetate, n-butyl acetate, toluene, xylene, methanol, ethanol, isopropanol, and n-propanol. Those solvents may be used alone or in combination of two or more kinds.

The concentration of the cellulose-based solution is not particularly limited, and is preferably 1 to 20% by weight, more preferably 5 to 15% by weight. In the case where the concentration is less than 1% by weight, the adhesion between the polarizer protective film of the present invention and the polarizer may not be exhibited sufficiently. When the concentration exceeds 20% by weight, high heat resistance, high transparency, high optical characteristics, and high mechanical strength may not be exhibited sufficiently in the polarizer protective film of the present invention.

The drying temperature after the cellulose-based resin solution is applied to the transparent resin layer is preferably 50° C. to 130° C., and more preferably 80° C. to 120° C. The drying time is preferably 30 seconds to 5 minutes, and more preferably 30 seconds to 2 minutes. The remaining amount of the solvent can be reduced by increasing the drying temperature or prolonging the drying time. It is preferred that these drying conditions may not decrease production efficiency.

The dried thickness of the cellulose-based resin layer in the present invention is preferably 0.3 to 3 μm, and more preferably 0.5 to 2.5 μm. When the thickness is out of the range, the remaining amount of the solvent in the cellulose-based resin layer is likely to increase, and the storage elastic modulus at a high temperature decreases due to the decrease in Tg of the cellulose-based resin layer, and the change amount of the polarizer increases when the polarizing plate is exposed to heating, with the result that polarizer cracks are likely to occur. Further, when the thickness is out of the range, in the case where a polarizing plate is configured, the adhesion (reworking property) may decrease and the viewing angle characteristics of a transmittance may decrease.

A crosslinking agent (“crosslinking agent” in the present invention refers to a compound having a functional group that is capable of reacting with a hydroxyl group in a molecule of the cellulose-based resin to form a covalent bond or that is capable of forming an intermolecular bond such as a hydrogen bond) is added to a cellulose-based resin to enhance the cohesion force of the cellulose-based resin layer, whereby the adhesion with respect to the polarizer is enhanced further.

Examples of the crosslinking agent include: alkylene diamines having an alkylene group and two amino groups such as ethylene diamine, triethylene diamine, and hexamethylene dimamine; isocyanates such as tolylene diisocyanate, hydrogenated tolylene diisocyanate, trimethylol propane tolylene diisocyanate adduct, triphenylmethane triisocyanate, methylene bis(4-phenylmethane triisocyanate), isophorone diisocyanate, and ketoxime blocked compounds thereof or phenol blocked compounds thereof; epoxides such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino/formaldehyde resin such as a condensate of formaldehyde with methylolurea, methylolmelamine, alkylated methylolurea, alkylated methylol melamine, acetoguanamine, or benzoguanamine; and salts of divalent metals or trivalent metals such as sodium, potassium, magnesium, calcium, aluminum, iron, and nickel and oxides thereof. In addition, various coupling agents such as silane coupling agents and titanium coupling agents can be exemplified.

The use amount of the crosslinking agent is set so that the number of functional groups capable of reacting with or interacting with functional groups of the cellulose-based resin is preferably three times or less, more preferably twice or less, and still more preferably 1.5 times or less with respect to the number of functional groups such as hydroxyl groups of the cellulose-based resin. Specifically, the use amount of the crosslinking agent generally is preferably 0.1 to 40 parts by weight, more preferably 1 to 35 parts by weight, still more preferably 10 to 30 parts by weight with respect to 100 parts by weight of the cellulose-based resin. In such a range, a polarizing plate that has uniform polarization properties and are excellent in adhesion with a polarizer and excellent in durability can be obtained.

### A-3. Polarizer Protective Film

As the polarizer protective film of the present invention in which the cellulose-based resin layer is provided on the transparent protective layer, a film that is subjected to a hydrophilicization treatment can be used for the adhesion to the polarizer. Examples of the hydrophilicization treatment include dry treatments such as an alkali treatment, a plasma treatment, and a corona treatment. Of those, hydrophilicization treatments, the alkali treatment is preferred. The alkali treatment is performed by soaking the transparent protective layer provided with the cellulose-based resin layer in 1 to 20% by weight of a sodium hydroxide aqueous solution adjusted to about 30° C. to 95° C. for about 10 seconds to 20 minutes and subjecting the transparent protective layer to a saponification treatment. After the saponification treatment, the transparent protective layer is washed with pure water, followed by drying.

### B. Polarizing Plate

The polarizing plate of the present invention has a configuration in which the cellulose-based resin layer side of the polarizer protective film of the present invention is laminated on at least one surface of the polarizer formed of a polyvinyl alcohol-based resin.

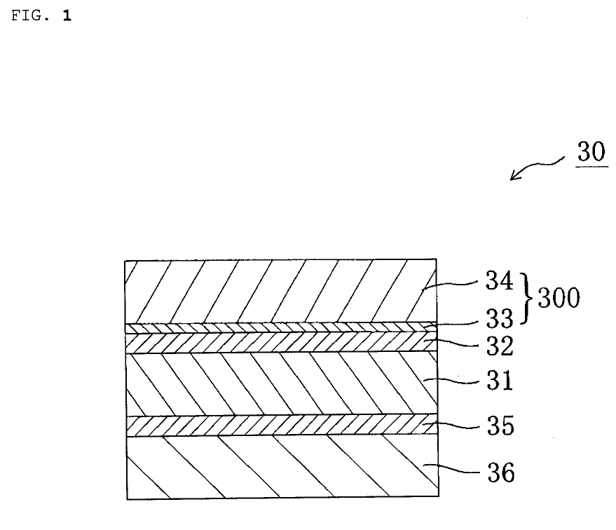

As shown in FIG. 1, one preferred embodiment of the polarizing plate of the present invention has a configuration in which one surface of a polarizer 31 is attached to a polarizer protective film 300 of the present invention formed of a cellulose-based resin layer 33 and a transparent resin layer 34 via an adhesive layer 32, and the other surface of the polarizer 31 is attached to a polarizer protective film 36 via an adhesive layer 35. The polarizer protective film 36 may be the polarizer protective film 300 of the present invention or another any suitable polarizer protective film.

The polarizer formed of a polyvinyl alcohol-based resin is generally manufactured by: coloring a polyvinyl alcohol-based resin film with a dichromatic substance (typically, iodine or a dichromatic dye); and uniaxially stretching the film. The degree of polymerization of the polyvinyl alcohol-based resin for forming the polyvinyl alcohol-based resin film is preferably 100 to 5,000, and more preferably 1,400 to 4,000. The polyvinyl alcohol-based resin film for forming the polarizer may be formed by any appropriate method (such as a flow casting method involving film formation through flow casting of a solution containing a resin dissolved in water or an organic solvent, a casting method, or an extrusion method). The thickness of the polarizer may be appropriately set in accordance with the purpose and application of LCD employing the polarizing plate, but is typically 5 to 80 μm.

For producing a polarizer, any appropriate method may be employed in accordance with the purpose, materials to be used, conditions, and the like. Typically, employed is a method in which the polyvinyl alcohol-based resin film is subjected to a series of production steps including swelling, coloring, cross-linking, stretching, water washing, and drying steps. In each of the treatment steps excluding the drying step, the polyvinyl alcohol-based resin film is immersed in a bath containing a solution to be used in each step. The order, number of times, and absence or presence of swelling, coloring, cross-linking, stretching, water washing, and drying steps may be appropriately set in accordance with the purpose, materials to be used, conditions, and the like. For example, several treatments may be conducted at the same time in one step, or specific treatments may be omitted. More specifically, stretching treatment, for example, may be conducted after coloring treatment, before coloring treatment, or at the same time as swelling treatment, coloring treatment, and cross-linking treatment. Further, for example, cross-linking treatment can be preferably conducted before and after stretching treatment. Further, for example, water washing treatment may be conducted after each treatment or only after specific treatments.

The swelling step is typically conducted by immersing the polyvinyl alcohol-based resin film in a treatment bath (swelling bath) filled with water. This treatment allows washing away of contaminants from a surface of the polyvinyl alcohol-based resin film, washing away of an anti-blocking agent, and swelling of the polyvinyl alcohol-based resin film, to thereby prevent non-uniformity such as uneven coloring. The swelling bath may appropriately contain glycerin, potassium iodide, or the like. The temperature of the swelling bath is typically about 20 to 60° C., and the immersion time in the swelling bath is typically about 0.1 to 10 minutes.

The coloring step is typically conducted by immersing the polyvinyl alcohol-based resin film in a treatment bath (coloring bath) containing a dichromatic substance such as iodine. As a solvent to be used for a solution of the coloring bath, water is generally used, but an appropriate amount of an organic solvent having compatibility with water may be added. The dichromatic substance is typically used in a ratio of 0.1 to 1.0 part by weight with respect to 100 parts by weight of the solvent. In the case where iodine is used as a dichromatic substance, the solution of the coloring bath preferably further contains an assistant such as an iodide for improving a coloring efficiency. The assistant is used in a ratio of preferably 0.02 to 20 parts by weight, and more preferably 2 to 10 parts by weight with respect to 100 parts by weight of the solvent. Specific examples of the iodide include potassium iodide, lithium iodide, sodium iodide, zinc iodide, aluminum iodide, lead iodide, copper iodide, barium iodide, calcium iodide, tin iodide, and titanium iodide. The temperature of the coloring bath is typically about 20 to 70° C., and the immersion time in the coloring bath is typically about 1 to 20 minutes.

The cross-linking step is typically conducted by immersing in a treatment bath (cross-linking bath) containing a cross-linking agent the polyvinyl alcohol-based resin film that has undergone the coloring treatment. The cross-linking agent employed may be any appropriate cross-linking agent. Specific examples of the cross-linking agent include: a boron compound such as boric acid or borax; glyoxal; and glutaraldehyde. The cross-linking agent may be used alone or in combination. As a solvent to be used for a solution of the cross-linking bath, water is generally used, but an appropriate amount of an organic solvent having compatibility with water may be added. The cross-linking agent is typically used in a ratio of 1 to 10 parts by weight with respect to 100 parts by weight of the solvent. In the case where a concentration of the cross-linking agent is less than 1 part by weight, sufficient optical properties are often not obtained. In the case where the concentration of the cross-linking agent is more than 10 parts by weight, stretching force to be generated on the film during stretching increases and a polarizing plate to be obtained may shrink. The solution of the cross-linking bath preferably further contains an assistant such as an iodide for obtaining uniform properties in the same plane. The concentration of the assistant is preferably 0.05 to 15 wt %, and more preferably 0.5 to 8 wt %. Specific examples of the iodide are the same as in the case of the coloring step. The temperature of the cross-linking bath is typically about 20 to 70° C., and preferably 40 to 60° C. The immersion time in the cross-linking bath is typically about 1 second to 15 minutes, and preferably 5 seconds to 10 minutes.

The stretching step may be conducted at any stage as described above. Specifically, the stretching step may be conducted after the coloring treatment, before the coloring treatment, at the same time as the swelling treatment, the coloring treatment, and the cross-linking treatment, or after the cross-linking treatment. A cumulative stretching ratio of the polyvinyl alcohol-based resin film must be 5 times or more, preferably 5 to 7 times, and more preferably 5 to 6.5 times. In the case where the cumulative stretching ratio is less than 5 times, a polarizing plate having a high degree of polarization may be hard to obtain. In the case where the cumulative stretching ratio is more than 7 times, the polyvinyl alcohol-based resin film (polarizer) may easily break. A specific method of stretching employed may be any appropriate method. For example, in the case where a wet stretching method is employed, a polyvinyl alcohol-based resin film is stretched in a treatment bath (stretching bath) to a predetermined ratio. A solution of the stretching bath to be preferably used is a solution in which various metal salts or compounds of iodine, boron, or zinc are added to a solvent such as water or an organic solvent (such as ethanol).

The water washing step is typically conduced by immersing in a treatment bath (water washing bath) the polyvinyl alcohol-based resin film that has undergone the various treatments. The water washing step allows washing away of unnecessary remains from the polyvinyl alcohol-based resin film. The water washing bath may contain pure water or an aqueous solution containing iodide (such as potassium iodide or sodium iodide). The concentration of an aqueous iodide solution is preferably 0.1 to 10% by weight. The aqueous iodide solution may contain an assistant such as zinc sulfate or zinc chloride. The temperature of the water washing bath is preferably 10 to 60° C., and more preferably 30 to 40° C., and the immersion time is typically 1 second to 1 minute. The water washing step may be conducted only once, or may be conducted a plurality of times as required. In the case where the water washing step is conducted a plurality of times, the kind and concentration of the additive contained in the water washing bath to be used for each treatment may appropriately be adjusted. For example, the water washing step includes a step of immersing a polymer film in an aqueous potassium iodide solution (0.1 to 10% by weight, 10 to 60° C.) for 1 second to 1 minute and a step of washing the polymer film with pure water.

The drying step may employ any appropriate drying method (such as natural drying, air drying, or heat drying). For example, in heat drying, a drying temperature is typically 20 to 80° C., and a drying time is typically 1 to 10 minutes. In such a manner as described above, the polarizer is obtained.

The polarizing plate of the present invention includes the polarizer and the polarizer protective film of the present invention. It is preferred that an adhesive layer be provided between the cellulose-based resin layer of the polarizer protective film and the polarizer.

The adhesive layer is preferably a layer formed of a polyvinyl alcohol-based adhesive. The polyvinyl alcohol-based adhesive contains a polyvinyl alcohol-based resin and a cross-linking agent.

Examples of the above-mentioned polyvinyl alcohol-based resin include without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft polymer, phosphate, or the like. Examples of the monomer include: unsaturated carboxylic acids such as maleic acid (anhydrides), fumaric acid, crotonic acid, itaconic acid, and (meth)acrylic acid and esters thereof; α-olefin such as ethylene and propylene; (sodium) (meth)allylsulfonate; sodium sulfonate(monoalkylmalate); sodium disulfonate alkylmalate; N-methylol acrylamide; alkali salts of acrylamide alkylsulfonate; N-vinylpyrrolidone; and derivatives of N-vinylpyrrolidone. The polyvinyl alcohol-based resins may be used alone or in combination.

The polyvinyl alcohol-based resin has an average degree of polymerization of preferably 100 to 3,000, and more preferably 500 to 3,000, and an average degree of saponification of preferably 85 to 100 mol %, and more preferably 90 to 100 mol %.

A polyvinyl alcohol-based resin having an acetoacetyl group may be used as the above-mentioned polyvinyl alcohol-based resin. The polyvinyl alcohol-based resin having an acetoacetyl group is a polyvinyl alcohol-based adhesive having a highly reactive functional group and is preferred from the viewpoint of improving durability of a polarizing plate.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl modification of less than 0.1 mol % provides insufficient water resistance with the adhesive layer and is inappropriate. The degree of acetoacetyl modification is preferably 0.1 to 40 mol %, and more preferably 1 to 20 mol %. A degree of acetoacetyl modification of more than 40 mol % decreases the number of reaction sites with a cross-linking agent and provides a small effect of improving the water resistance. The degree of acetoacetyl modification is a value measured by NMR.

As the above-mentioned cross-linking agent, the one used for a polyvinyl alcohol-based adhesive can be used without particular limitation. A compound having at least two functional groups each having reactivity with a polyvinyl alcohol-based resin can be used as the cross-linking agent. Examples of the compound include: alkylene diamines having an alkylene group and two amino groups such as ethylene diamine, triethylene amine, and hexamethylene diamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethanetriisocyanate, isophorone diisocyanate, and ketoxime blocked compounds and phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino-formaldehyde resin such as a condensate of formaldehyde with methylol urea, methylol melamine, alkylated methylol urea, alkylated methylol melamine, acetoguanamine, or benzoguanamine; and salts of divalent or trivalent metals such as sodium, potassium, magnesium, calcium, aluminum, iron, and nickel and oxides thereof. A melamine-based cross-linking agent is preferred as the cross-linking agent, and methylolmelamine is particularly preferred.

A mixing amount of the cross-linking agent is preferably 0.1 to 35 parts by weight, and more preferably 10 to 25 parts by weight with respect to 100 parts by weight of the polyvinyl alcohol-based resin. Meanwhile, for improving the durability, the cross-linking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the cross-linking agent is preferably used in an amount of more than 30 parts by weight. The cross-linking agent is mixed within a range of more than 30 parts by weight and 46 parts by weight or less, to thereby improve the water resistance.

The above-mentioned polyvinyl alcohol-based adhesive can also contain a coupling agent such as a silane coupling agent or a titanium coupling agent, various kinds of tackifiers, a UV absorber, an antioxidant, a stabilizer such as a heat-resistant stabilizer or a hydrolysis-resistant stabilizer.

The above-mentioned adhesive layer is formed by applying the above-mentioned adhesive on either side or both sides of a polarizer protective film, and on either side or both sides of a polarizer. After the polarizer protective film and the polarizer are attached to each other, a drying step is performed, to thereby form an adhesive layer made of an applied dry layer. After the adhesive layer is formed, the polarizer and the polarizer protective film may also be attached to each other. The polarizer and the polarizer protective film are attached to each other with a roll laminator or the like. The heat-drying temperature and the drying time are appropriately determined depending upon the kind of an adhesive.

Too large thickness of the adhesive layer after drying is not preferred in view of the adhesive property of the polarizer protective film. Therefore, the thickness of the adhesive layer is preferably to 10 μm, and more preferably 0.03 to 5 μm.

The attachment of the polarizer protective film to the polarizer can be performed by bonding one side of the polarizer protective film on both sides of the polarizer.

Further, the attachment of the polarizer protective film to the polarizer can be performed by bonding one side of the polarizer protective film to one surface of the polarizer and attaching a cellulose-based resin to the other surface of the polarizer.

The cellulose-based resin is not particularly limited. However, triacetyl cellulose is preferred in terms of transparency and an adhesive property. The thickness of the cellulose-based resin is preferably 30 to 100 μm, and more preferably 40 to 80 μm. When the thickness is smaller than 30 μm, the film strength decreases to degrade workability, and when the thickness is larger than 100 μm, the light transmittance decreases remarkably in terms of durability.

The polarizing plate according to the present invention may have a pressure-sensitive adhesive layer as at least one of an outermost layer (such a polarizing plate may be referred to as polarizing plate of a pressure-sensitive adhesion type). As a particularly preferred embodiment, a pressure-sensitive adhesive layer for bonding of other members such as another optical film and a liquid crystal cell can be provided to an opposite side of the polarizer of the above-mentioned polarizer protective film.

The pressure-sensitive adhesive forming the above-mentioned pressure-sensitive adhesive layer is not particularly limited. However, for example, a pressure-sensitive adhesive containing as a base polymer an acrylic polymer, a silicone-based polymer, polyester, polyurethane, polyamide, polyether, a fluorine or rubber-based polymer can be appropriately selected to be used. In particular, a pressure-sensitive adhesive such as an acrylic pressure-sensitive adhesive is preferably used, which is excellent in optical transparency, exhibits appropriate wettability and pressure-sensitive adhesion properties of a cohesive property and an adhesive property, and is excellent in weather resistance and heat resistance. In particular, an acrylic pressure-sensitive adhesive made of an acrylic polymer containing 4 to 12 carbon atoms is preferred.

In addition to the above, in terms of the prevention of a foaming phenomenon and a peeling phenomenon caused by moisture absorption, the prevention of a degradation in optical properties and bending of a liquid crystal cell caused by thermal expansion difference or the like, and the formation property of a liquid crystal display apparatus which is of high quality and has excellent durability, a pressure-sensitive adhesive layer having a low moisture absorbing ratio and excellent heat resistance is preferred.

The above-mentioned pressure-sensitive adhesive layer may contain, for example, resins of a natural substance or a synthetic substance, in particular, additives to be added to the pressure-sensitive adhesive layer, a tackifying resin, a filler such as glass fibers, glass beads, metal powder, or other inorganic powders, a pigment, a colorant, and an antioxidant.

A pressure-sensitive adhesive layer that contains fine particles and exhibits a light diffusion property or the like may be used.

The above-mentioned pressure-sensitive adhesive layer can be provided by any appropriate method. Examples thereof include a method of preparing a pressure-sensitive adhesive solution in an amount of about 10 to 40% by weight in which a base polymer or a composition thereof is dissolved or dispersed in any appropriate single solvent such as toluene or ethyl acetate or a solvent made of a mixture, and directly applying the pressure-sensitive adhesive solution onto a polarizing plate or an optical film by any appropriate development method such as a flow casting method or a coating method, or forming a pressure-sensitive adhesive layer on a separator according to the above, and moving the pressure-sensitive adhesive layer to the polarizer protective film surface.

The pressure-sensitive adhesive layer may also be provided on one surface or both surfaces of a polarizing plate as superimposed layers of different compositions, different kinds, or the like. In the case of providing the pressure-sensitive adhesive layer on both surfaces of the polarizing plate, pressure-sensitive adhesive layers on front and reverse surfaces of the polarizing plate can have different compositions, kinds, thicknesses, and the like.

The thickness of the pressure-sensitive adhesive layer can be determined appropriately in accordance with the use purpose and the adhesive strength, and preferably 1 to 40 μm, more preferably 5 to 30 μm, and particularly preferably 10 to 25 μm. When the thickness of the pressure-sensitive adhesive layer is smaller than 1 μm, durability of the layer degrades. When the thickness of the pressure-sensitive adhesive layer is larger than 40 μm, lifting and peeling are likely to occur due to foaming or the like, resulting in an unsatisfactory outer appearance.

In order to enhance the contactness between the above-mentioned polarizer protective film and the above-mentioned pressure-sensitive adhesive layer, an anchor layer can also be provided therebetween.

As the anchor layer, preferably, an anchor layer selected from polyurethane, polyester, and polymers containing amino groups in molecules is used, and in particular, polymers containing amino groups in molecules are preferably used. In the polymer containing an amino group in molecules, an amino group in the molecules reacts with a carboxyl group in the pressure-sensitive adhesive or a polar group in a conductive polymer, or exhibits an interaction such as an ion interaction, so satisfactory contactness is ensured.

Examples of the polymers containing amino groups in molecules include polyethyleneimine, polyallylamine, polyvinylamine, polyvinylpyridine, polyvinylpyrrolidine, and a polymer of an amino group-containing monomer such as dimethylaminoethyl acrylate shown in the above-mentioned copolymerized monomer of the acrylic pressure-sensitive adhesive.

In order to provide the above-mentioned anchor layer with an antistatic property, an antistatic agent can also be added. Examples of the antistatic agent for providing an antistatic property include an ionic surfactant, a conductive polymer such as polyaniline, polythiophene, polypyrrole, and polyquinoxaline, and a metal oxide such as tin oxide, antimony oxide, and indium oxide. Particularly, in view of optical properties, an outer appearance, an antistatic effect, and stability of an antistatic effect under heat or humidity, the conductive polymers are used preferably. Of those, a water-soluble conductive polymer such as polyaniline and polythiophene, or a water-dispersion conductive polymer is particularly preferably used. The reason for this is as follows: in the case of using a water-soluble conductive polymer or a water-dispersion conductive polymer as a material for forming an antistatic layer, the deterioration of an optical film base caused by an organic solvent can be suppressed in the process of coating.

In the present invention, each layer of a polarizer and a polarizer protective film forming the above-mentioned polarizing plate, and the pressure-sensitive adhesive layer may be provided with a UV absorbing ability, for example, by the treatment with a UV absorbing agent such as a salicylateester-based compound, a benzophenol-based compound, benzotriazol-based compound, a cyanoacrylate-based compound, and a nickel complex salt-based compound.

The polarizing plate of the present invention may be provided on either one of a viewer side and a backlight side of a liquid crystal cell or on both sides thereof without particular limitation.

### C. Image Display Apparatus

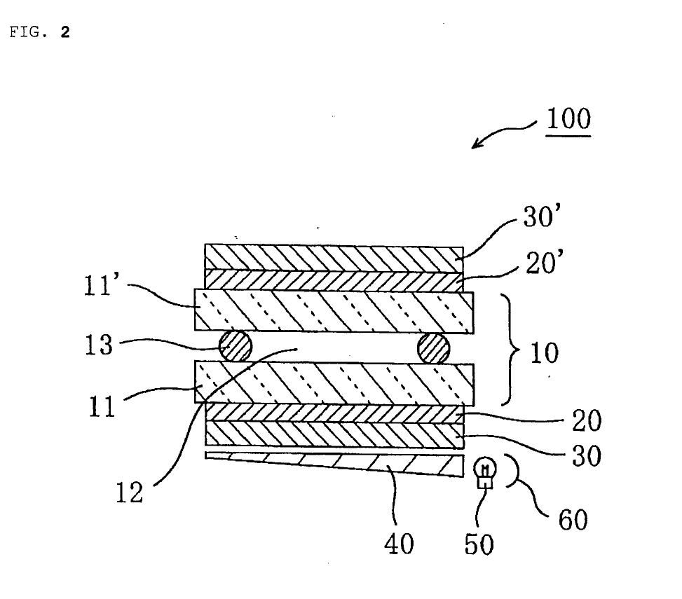

Next, an image display apparatus of the present invention will be described. The image display apparatus of the present invention includes at least one polarizing plate of the present invention. Herein, as one example, a liquid crystal display apparatus will be described. However, it is needless to say that the present invention is applicable to any display apparatus requiring a polarizing plate. Specific examples of the image display apparatus to which the polarizing plate of the present invention is applicable include a self-emitting display apparatus such as an electroluminescence (EL) display, a plasma display (PD), and a field emission display (FED). FIG. 2 is a schematic cross-sectional view of a liquid crystal display apparatus according to a preferred embodiment of the present invention. In the illustrated example, a transmission-type liquid crystal display apparatus will be described. However, it is needless to say that the present invention is also applicable to a reflection-type liquid crystal display apparatus or the like.

A liquid crystal display apparatus 100 includes a liquid crystal cell 10, retardation films 20 and 20′ placed so as to interpose the liquid crystal cell 10 therebetween, polarizing plates 30 and 30′ placed on outer sides of the retardation films 20 and 20′, a light guide plate 40, a light source 50, and a reflector 60. The polarizing plates 30 and 30′ are placed so that polarization axes thereof are perpendicular to each other. The liquid crystal cell 10 includes a pair of glass substrates 11 and 11′ and a liquid crystal layer 12 as a display medium placed between the substrates. One glass substrate 11 is provided with a switching element (typically, TFT) for controlling the electrooptical properties of liquid crystals, a scanning line for providing agate signal to the switching element, and a signal line for providing a source signal to the switching element (all of them are not shown). The other glass substrate 11′ is provided with a color layer forming a color filter and a shielding layer (black matrix layer) (both of them are not shown). A distance (cell gap) between the glass substrates 11 and 11′ is controlled by a spacer 13. In the liquid crystal display apparatus of the present invention, the polarizing plate of the present invention described above is employed as at least one of the polarizing plates 30 and 30′.

For example, in the case of the liquid crystal display apparatus 100 employing a TN mode, liquid crystal molecules of the liquid crystal layer 12 are aligned in a state with respective polarization axes being shifted by 90° during application of no voltage. In such a state, injected light including light in one direction transmitted through the polarizing plate is twisted 90° by the liquid crystal molecules. As described above, the polarizing plates are arranged such that the respective polarization axes are perpendicular to each other, and thus light (polarized light) reaching the other polarizing plate transmits through the polarizing plate. Thus, during application of no voltage, the liquid crystal display apparatus 100 provides a white display (normally white mode). Meanwhile, in the case where a voltage is applied onto the liquid crystal display apparatus 100, alignment of the liquid crystal molecules in the liquid crystal layer 12 changes. As a result, the light (polarized light) reaching the other polarizing plate cannot transmit through the polarizing plate, and a black display is provided. Displays are switched as described above by pixel by using the active element, to thereby form an image.

### EXAMPLES

Hereinafter, the present invention will be described specifically with reference to Examples, but the present invention is not limited to Examples. Note that, unless otherwise noted, parts and % in Examples are based on weight. Evaluation was performed as follows.

### <Mass(Weight) Average Molecular Weight>

The mass(weight) average molecular weight was measured by polystyrene conversion, using Shodex GPC system-21H manufactured by Showa Denko K.K.

<Tg (Glass Transition Temperature, which May be Referred to as TG>

A polymer was once dissolved in tetrahydrofuran, and the resultant solution was placed in excessive hexane, followed by reprecipitation and filtration. The precipitate thus obtained was subjected to drying under reduced pressure (1 mmHg (1.33 hPa), 3 or more hours), to thereby remove a volatile constituent. The obtained resin was measured for a Tg, using a DSC apparatus (DSC 8230 manufactured by Rigaku Co., Ltd.). Note that the transparent resin layer or the film was cut to small pieces according to the measurement cell size, and measured for a Tg with the reprecipitation above not being operated.

### <Dealcoholization Reaction Rate (Lactone Ring Structure Unit Rate)>

The dealcoholization reaction rate was obtained from the weight reduction caused by a dealcoholization reaction from 150° C., which is prior to the starting of the weight reduction, to 300° C., which is prior to the starting of the decomposition of a polymer, by dynamic TG measurement, based on the weight reduction amount occurring at a time when all the hydroxyl groups are dealcoholized as methanol from a polymer composition obtained in polymerization.

That is, the weight reduction rate from 150° C. to 300° C. by the dynamic TG measurement of a polymer having a lactone ring structure is measured, and the obtained measured weight reduction rate is defined as (X). On the other hand, the theoretical weight reduction rate (i.e., the weight reduction rate calculated assuming that 100% dealcoholization occurred on the composition) assuming that all the hydroxyl groups contained in the polymer composition participate in the formation of a lactone ring to become alcohol, resulting in dealcoholization, from the polymer composition, is defined as (Y). More specifically, the theoretical weight reduction rate (Y) can be calculated from a molar ratio of a material monomer having a structure (hydroxyl group) participating in a dealcoholization reaction in a polymer, that is, the content of the material monomer in the polymer composition. Those values (X, Y) are substituted into a dealcoholization calculation expression: 1−(measured weight reduction rate(X)/theoretical weight reduction rate(Y)), and the obtained value is expressed by %, to thereby obtain a dealcoholization reaction rate (lactone cyclization rate).

### <Melt Flow Rate>

The melt flow rate was measured at a test temperature of 240° C. and a load of 10 kg based on JIS-K6874.

### <Adhesion Evaluation (Rework Test)>

To a separable flask equipped with a thermometer, a stirrer, a reflux cooling tube, and a nitrogen gas introducing tube, 100 parts by weight of butyl acrylate, 5 parts by weight of acrylic acid, 0.4 parts by weight of benzoyl peroxide, and ethyl acetate were placed so as to obtain 70% by weight of effective components. Nitrogen substitution was performed for about one hour while nitrogen gas was allowed to flow with stirring. Then, the separable flask was heated to 60° C. to start a reaction. The mixture was allowed to react for 6 hours to obtain a base polymer. The molecular weight of the base polymer was 1,600,000.

To 100 parts by weight (solid content) of the base polymer, 0.8 parts by weight of a polyfunctional isocyanate compound (COLONATE L manufactured by Nippon Polyurethane Industry Co., Ltd.) and 0.02 parts by weight of a silane coupling agent (KBM403 manufactured by Shin-Etsu Chemical Co., Ltd.) were added to prepare an acrylic pressure-sensitive adhesive. The acrylic pressure-sensitive adhesive was applied to a polyethylene terephthalate film with a thickness of 38 μm subjected to a peeling treatment, and dried at 150° C. for 3 minutes to obtain a pressure-sensitive adhesive sheet with a thickness of 25 μm.

A sample (pressure-sensitive adhesive type polarizing plate) obtained by attaching the pressure-sensitive adhesive layer of the pressure-sensitive adhesive sheet to the surface of a (meth)acrylic resin layer of a polarizing plate and removing a polyethylene terephthalate film was attached to test glass (non-alkali glass plate with a thickness of 0.7 mm and a size of 300 mm×220 mm) using a roller. Then, the obtained sample was placed in an autoclave (50° C., 5 atm×15 minutes), and thereafter, the pressure-sensitive adhesive type polarizing plate was peeled from the glass slowly to perform a rework test.

⊚: The polarizing plate is peeled neatly even if a force is applied rapidly.
◯: The polarizing plate is peeled neatly.
X: The polarizer protective film remains on the glass.

### (Viewing Angle Characteristics of a Transmittance)

The same two polarizing plates were laminated so that polarization axes were orthogonal to each other, and a transmittance at a tilt angle of 70° from a normal direction was measured at an azimuth direction of 45′ with respect to the absorption axis of one polarizing plate. The transmittance was measured using a spectrophotometer (U-4100 manufactured by Hitachi Ltd.). The transmittance is a Y-value with a visibility corrected by a visual field of 2 degrees (C light source) of JIS Z8701.

### Production Example 1

### Production of Polarizer

A polyvinyl alcohol film with a thickness of 80 μm was dyed in a 5% by weight of an iodine aqueous solution (weight ratio: iodine/potassium iodide=1/10). Then, the resultant polyvinyl alcohol film was soaked in an aqueous solution containing 3% by weight of boric acid and 2% by weight of potassium iodide. Further, the polyvinyl alcohol film was stretched by 6.0 times in an aqueous solution containing 4% by weight of boric acid and 3% by weight of potassium iodide, and thereafter, the polyvinyl alcohol film was soaked in a 5% by weight of a potassium iodide aqueous solution. After that, the polyvinyl alcohol film was dried in an oven at 40° C. for 3 minutes to obtain a polarizer with a thickness of 30 μm.

### Production Example 2

### Production of a Lactone Ring-Containing Acrylic Resin

In a 30-L reaction vessel equipped with a stirring device, a temperature sensor, a cooling pipe, and a nitrogen introduction pipe, 8,000 g of methyl methacrylate (MMA), 2,000 g of methyl 2-(hydroxymethyl)acrylate (MHMA), and 10,000 g of toluene were placed, and the mixture was heated to 105° C. while nitrogen was being introduced thereto. After reflux, while 10.0 g of tert-amylperoxy isononanoate (Lupasol 570 (Trade name) manufactured by ATOFINA YOSHITOMI LTD.) was added as an initiator, and at the same time, a solution containing 20.0 g of the initiator and 100 g of toluene were dropped over 4 hours, the mixture was subjected to solution polymerization under reflux (about 105 to 110° C.), and further aged over 4 hours.

To the resultant polymer solution, 10 g of a stearyl phosphate/distearyl phosphate mixture (Phoslex A-18 (Trade name) manufactured by Sakai Chemical Industry Co., Ltd.) was added, and the polymer solution was subjected to ring condensation reaction under reflux (about 90 to 110° C.) for 5 hours. Then, the polymer solution obtained in the above-mentioned ring condensation reaction was introduced to a bent-type screw biaxial extruder (Φ=29.75 mm, L/D=30) of a barrel temperature of 260° C., a rotation number of 100 rpm, a decompression degree of 13.3 to 400 hPa (10 to 300 mmHg), one rear bent, and four fore bents, at a processing speed of 2.0 kg/hour in resin amount conversion. The polymer solution was subjected to ring condensation reaction and devolatilization in the extruder and extruded, to thereby obtain a transparent lactone ring-containing acrylic resin pellet.

The lactone cyclization ratio of the lactone ring-containing acrylic resin pellet was 97.0%, the mass average molecular weight thereof was 147,700, the melt flow rate thereof was 11.0 g/10 minutes, and the Tg (glass transition temperature) thereof was 130° C.

### Production Example 3

### Production of a Lacton Ring-Containing Acrylic Resin Film

The lacton ring-containing acrylic resin pellet obtained in Production Example 2 was supplied to an extruder. After the pellet was melt-kneaded at 250° C., the pellet was extruded from a T-die and was cooled with water upon being taken up by a cooling roll, whereby a film with a thickness of 100 μm was obtained. After that, the film was stretched vertically by 1.8 times (heating temperature: 140° C.) and horizontally by 2.4 times (heating temperature: 140° C.) with a sequential biaxial extruder to obtain a lactone ring-containing acrylic resin film, which was a biaxially stretched film with a thickness of 30 μm.

### Production Example 4

### Preparation of Aqueous Solution of Polyvinyl Alcohol-Based Adhesive

An aqueous solution of a polyvinyl alcohol-based adhesive was prepared by adding an aqueous solution containing 20 parts by weight of methylol melamine with respect to 100 parts by weight of a polyvinyl alcohol resin with an acetoacetyl group denatured (acetylation degree: 13%) so as to be a concentration of 0.5% by weight.

### Example 1

A solution in which a cellulose-based resin (cellulose acetate propionate manufactured by Eastman Chemical Company) was diluted (solid content concentration: 7.5% by weight) in butyl acetate was prepared. This solution was applied to one surface of the lactone ring-containing acrylic resin film produced in Production Example 3, and dried in an oven at 100° C. for 3 minutes, whereby a polarizer protective film (1A) with a cellulose-based resin layer was obtained. The thickness of the dried cellulose-based resin layer was 0.8 μm.

The cellulose-based resin layer surface of the polarizer protective film (1A) was attached to one surface of the polarizer obtained in Production Example 1 and a saponified triacetyl cellulose (TAC) film (UZ-T40 (Trade name) having a thickness of 40 μm, manufactured by Fujiphoto Film Co., Ltd.) was attached to the other surface, using the aqueous solution of polyvinyl alcohol-based adhesive prepared in Production Example 4. The laminate thus obtained was dried at 70° C. for 10 minutes to obtain a polarizing plate (1).

Regarding the obtained polarizing plate (1), the evaluation of adhesion (rework test) and the evaluation of viewing angle characteristics of a transmittance were performed. Table 1 shows the results.

### Example 2

The process was performed in the same way as in Example 1 except that the thickness of the dried cellulose-based resin layer was set to be 2.1 μm, whereby a polarizing plate (2) was obtained.

Regarding the obtained polarizing plate (2), the evaluation of adhesion (rework test) and the evaluation of viewing angle characteristics of a transmittance were performed. Table 1 shows the results.

### Example 3

A cellulose-based resin (cellulose acetate butyrate manufactured by Eastman Chemical Company) was diluted in a methyl ethyl ketone:methyl isobutyl ketone (7:3 (weight ratio)) mixed solvent (solid content concentration: 4% by weight). To this mixture, 27 parts by weight of hexamethylene diisocyanate were added based on 100 parts by weight of the cellulose-based resin. The solution thus obtained was applied to one surface of the lactone ring-containing acrylic resin film produced in Production Example 3 and dried in an oven at 75° C. for 3 minutes, whereby a polarizer protective film (1B) with a cellulose-based resin layer was obtained. The thickness of the dried cellulose-based resin layer was 0.8 μm.

The process was performed in the same way as in Example 1 except that the polarizer protective film (1B) with a cellulose-based resin layer was used in place of the polarizer protective film (1A) with a cellulose-based resin layer, whereby a polarizing plate (3) was obtained.

Regarding the obtained polarizing plate (3), the evaluation of adhesion (rework test) and the evaluation of viewing angle characteristics of a transmittance were performed. Table 1 shows the results.

### Comparative Example 1

The process was performed in the same way as in Example 1 except that a saponified triacetyl cellulose (TAC) film (UZ-T40 (Trade name) manufactured by Fuji Photo Film Co., Ltd.) with a thickness of 40 μm was used in place of the polarizer protective film (1A) with a cellulose-based resin layer, whereby a polarizing plate (C1) was obtained.

Regarding the obtained polarizing plate (C1), the evaluation of adhesion (rework test) and the evaluation of viewing angle characteristics of a transmittance were performed. Table 1 shows the results.

### Comparative Example 2

The process was performed in the same way as in Example 1 except that the cellulose-based resin layer was not provided, whereby polarizing plate (C2) was obtained.

Regarding the obtained polarizing plate (C2), the evaluation of adhesion (rework test) and the evaluation of viewing angle characteristics of a transmittance were performed. Table 1 shows the results.

### Comparative Example 3

The process was performed in the same way as in Example 1 except that the thickness of the dried cellulose-based resin layer was set to be 0.2 μm, whereby a polarizing plate (C3) was obtained.

Regarding the obtained polarizing plate (C3), the evaluation of adhesion (rework test) and the evaluation of viewing angle characteristics of a transmittance were performed. Table 1 shows the results.

### Comparative Example 4

The process was performed in the same way as in Example 1 except that the thickness of the dried cellulose-based resin layer was set to be 4.5 μm, whereby a polarizing plate (C4) was obtained.

Regarding the obtained polarizing plate (C4), the evaluation of adhesion (rework test) and the evaluation of viewing angle characteristics of a transmittance were performed. Table 1 shows the results.

TABLE 1

| | | Thickness of | | Viewing angle |
|---|---|---|---|---|
| | Polar- | cellulose-based | Evaluation of | characteristics |
| | izing | resin layer | adhesion | of a |
| | plate | (μm) | (rework test) | transmittance |
| Example 1 | (1) | 0.8 | ◯ | 1.3 |
| Example 2 | (2) | 2.1 | ◯ | 1.5 |
| Example 3 | (3) | 0.8 | ⊚ | 1.3 |
| Comparative | (C1) | None | ◯ | 3.8 |
| Example 1 | | | | |
| Comparative | (C2) | None | X | — |
| Example 2 | | | | |
| Comparative | (C3) | 0.2 | X | — |
| Example 3 | | | | |
| Comparative | (C4) | 4.5 | ◯ | 2.1 |
| Example 4 | | | | |

The following is understood from Table 1.

It is understood that the polarizing plates (1) to (3) using the polarizer protective film of the present invention adhesive satisfactory results of adhesion evaluation (rework test) and are also excellent in viewing angle characteristics of a transmittance.

It is understood that the polarizing plate (C1) obtained by using the TAC film in place of the lactone ring-containing acrylic resin film with a cellulose-based resin layer has inferior viewing angle characteristics of a transmittance.

It is understood that the polarizing plate (C2) obtained by using the lactone ring-containing acrylic resin film without a cellulose-based resin layer in place of the lactone ring-containing acrylic resin film with a cellulose-based resin layer is inferior in the results of adhesion evaluation (rework test).

It is understood that the polarizing plate (C3) in which the thickness of a cellulose-based resin layer in the lactone ring-containing acrylic resin film with a cellulose-based resin layer is 0.2 μm is inferior in the results of adhesion evaluation (rework test).

It is understood that the polarizing plate (C4) in which the thickness of a cellulose-based resin layer in the lactone ring-containing acrylic resin film with a cellulose-based resin layer is 4.5 μm is inferior in the results of adhesion evaluation (rework test).

### INDUSTRIAL APPLICABILITY

The polarizer protective film and the polarizing plate of the present invention can be preferably used for various kinds of image display apparatuses (liquid crystal display device, organic EL display device, PDP, etc.).

1. A polarizer protective film comprising a cellulose-based resin layer having a thickness of 0.3 to 3 μm on at least one surface of a transparent resin layer containing a (meth)acrylic resin having a lactone ring structure.

2. A polarizer protective film according to claim 1, wherein the cellulose-based resin layer is formed by applying a cellulose-based resin solution obtained by dissolving a cellulose-based resin in a solvent to at least one surface of the transparent resin layer, followed by drying.

3. A polarizing plate in which a cellulose-based resin layer side of the polarizer protective film according to claim 1 is laminated on at least one surface of a polarizer formed of a polyvinyl alcohol-based resin.

4. A polarizing plate according to claim 3, comprising an adhesion layer and an adhesive layer between the cellulose-based resin layer of the polarizer protective film and the polarizer.

5. A polarizing plate according to claim 4, wherein the adhesive layer is formed of a polyvinyl alcohol-based adhesive.

6. A polarizing plate according to claim 3, further comprising a pressure-sensitive adhesive layer as at least one of an outermost layer.

7. An image display apparatus comprising at least one polarizing plate according to claim 3.
